(19) United States
(12) Patent Application Publication
(10) Pub. No.: US 2014/0121858 A1
(43) Pub. Date: May 1, 2014

(54) Car Central Locking System Remote Control System

(71) Applicant: Shih-Yao CHEN, New Taipei City (TW)

(72) Inventor: Shih-Yao CHEN, New Taipei City (TW)

(21) Appl. No.: 13/664,612

(22) Filed: Oct. 31, 2012

(51) Int. Cl. G06F 17/00

(52) U.S. Cl. 701/2

(57) ABSTRACT

A car central locking system remote controller includes a smart phone, tablet PC. Notebook or any other wireless communication device, a central locking system driver for driving a pull rod to move a mechanical locking mechanism of a central locking system of a car to lock or unlock the doors of the car, and a main control box carrying a micro controller unit for controlling the central locking system driver and a wireless communication module electrically connected to the micro controller unit and adapted for establishing a communication protocol interface with the wireless communication device for enabling the micro controller unit to be controlled by the wireless communication device to drive the central locking system driver.

### BACKGROUND OF THE INVENTION

1. Field of the Invention

The present invention relates to car central locking technology and more particularly, to a car central locking system remote control system, which allows the user to control the central locking system of the car at a remote place using a smart phone, tablet PC, notebook, personal computer or any other mobile electronic apparatus.

2. Description of the Related Art

Conventional motor vehicles commonly allow the user to lock and unlock the central locking system (power door lock) manually with a key or using a remote controller, i.e., the driver can use a remote controller to lock or unlock the doors of the motor vehicle, or directly insert a key into the keyway of the door lock to lock or unlock the doors of the motor vehicle. Further, the driver side door lock is the central lock that controls the locking and unlocking of the other doors (passenger-side doors).

A car central locking system generally uses an electric drive to control a pull rod, driving the pull rod to pull a mechanical locking mechanism in locking or unlocking the doors of the car. The electric drive generally comprises a high torque motor, and a transmission gear train coupled between the high torque motor for moving the pull rod upon forward/backward rotation of the high torque motor.

Conventional car anti-theft devices commonly include two types, i.e., before-intrusion type anti-theft system and after-intrusion type anti-theft system. A before-intrusion anti-theft system generally includes an alarm connected in parallel to the central locking system for giving off an alarm sound or an alarm signal. An after-intrusion type anti-theft system generally includes a steering wheel lock, gearshift lock, automatic fuel shutoff device, circuit breaker, and/or satellite monitoring system.

Therefore, the effectiveness of the car central locking system determines the car door locking/unlocking convenience and the functioning of the locking mechanism and electromechanical control system of the car anti-theft device.

Regular car remote controllers commonly employ infrared or radio frequency to achieve remote control. The effective sensing range of regular car remote controllers is about 1˜5 meters. Even the advanced infrared technology is employed, the effective sensing range can simply reach 20˜50 meters. After left from the car, the car driver usually carry the car central locking system remote controller to a place far from the parking place beyond the effective sensing range where real-time monitoring and control are not applicable.

### SUMMARY OF THE INVENTION

The present invention has been accomplished under the circumstances in view. It is one object of the present invention to provide a car central locking system remote control system, which enables a user to control the central locking system of a car at a remote place using a 3G/4G, Bluetooth or Wi-Fi wireless communication device.

To achieve this and other objects of the present invention, a car central locking system remote control system comprises a wireless communication device, a central locking system driver installed in a motor vehicle for driving a pull rod to move a mechanical locking mechanism of a central locking system of the motor vehicle to lock or unlock the doors of the motor vehicle, and a main control box installed in the motor vehicle and electrically connected to the central locking system driver for controlling the central locking system driver to drive the pull rod. The main control box comprises a micro controller unit adapted for controlling the central locking system driver, a wireless communication module electrically connected to the micro controller unit and adapted for establishing a communication protocol interface with the wireless communication device for enabling the micro controller unit to be controlled by the wireless communication device to drive the central locking system driver.

Further, a motor vehicle anti-theft device is installed in the motor vehicle and electrically connected to and controllable by the central locking system driver. The motor vehicle anti-theft device can be an alarm, an automatic fuel shutoff device, a circuit breaker, or their combination.

Further, the wireless communication device can be a smart phone, a tablet computer, a notebook computer, or a personal computer.

### BRIEF DESCRIPTION OF THE DRAWINGS

FIG. 1 is block diagram of a car central locking system remote control system in accordance with the present invention.

FIG. 2 is a block diagram of the main control box of the car central locking system remote control system in accordance with the present invention.

### DETAILED DESCRIPTION OF THE PREFERRED EMBODIMENT

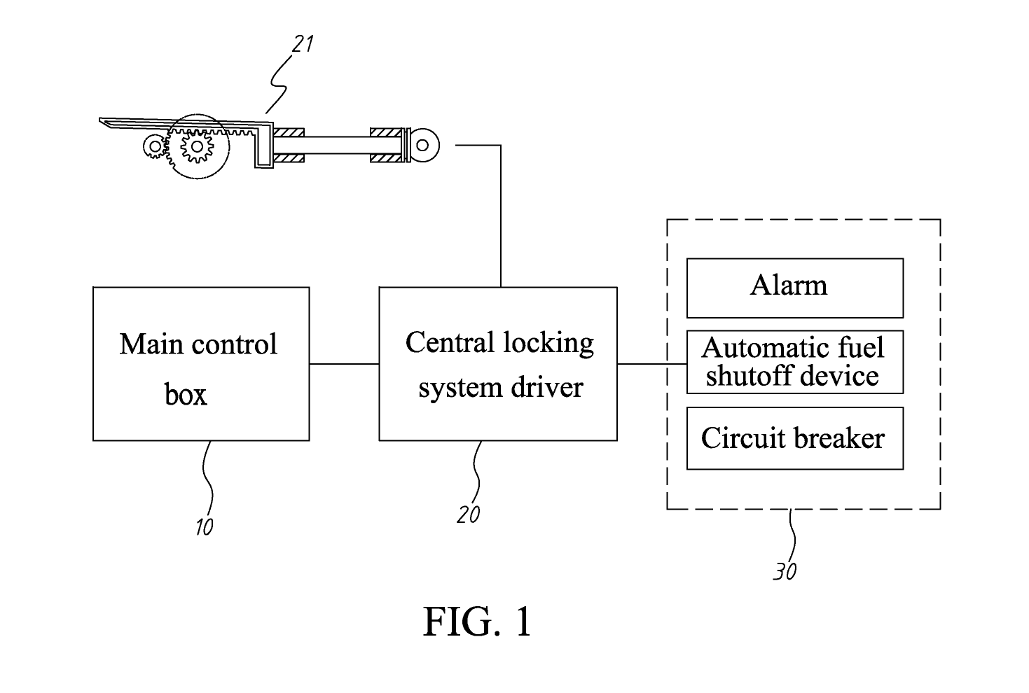

Referring to FIG. 1, a car central locking system remote control system in accordance with the present invention is shown comprising a main control box 10 that is controllable by a smart phone, table computer, notebook computer, or any 3G, 4G, Blue Tooth, or Wi-Fi wireless communication device.

The main control box 10 is mounted in a car and electrically connected to a central locking system driver 20 that is controllable by the main control box to drive a pull rod 21 in pulling the mechanical locking mechanism of the central locking system (not shown) to lock or unlock the doors of the car. Further, a car anti-theft device 30, which includes an alarm 31, an automatic fuel shutoff device 32 and/or a circuit breaker 33, is electrically connected to the a central locking system drive circuit device 20.

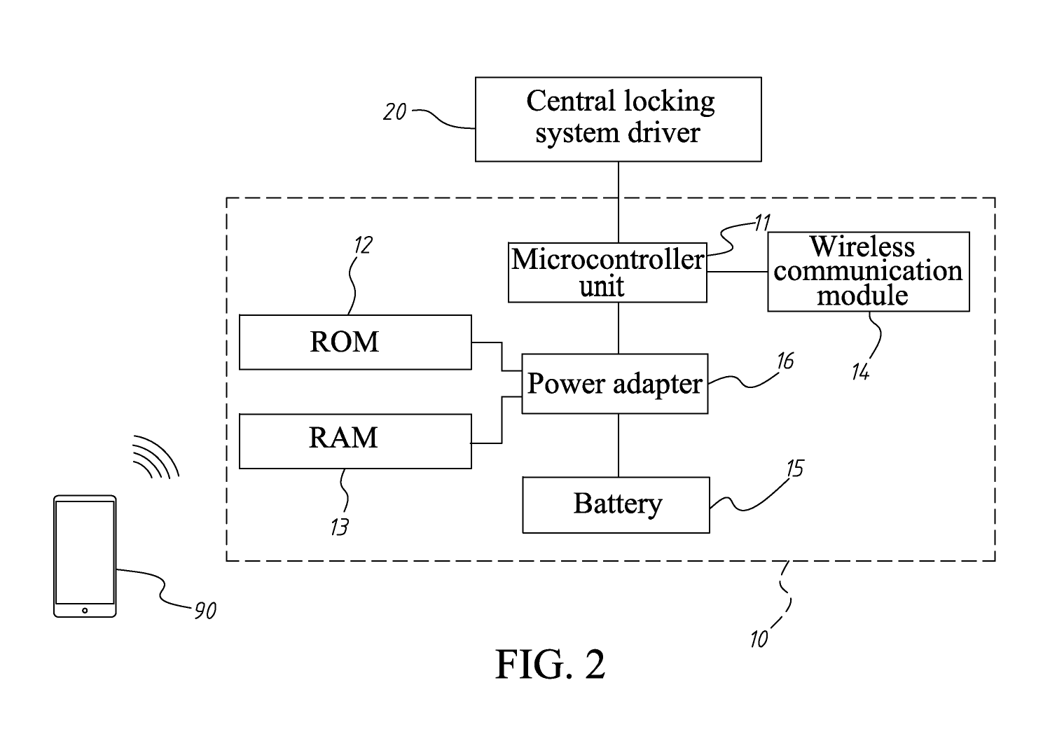

Referring to FIG. 2, the main control box 10 comprises a micro controller unit 11 that is capable of running an operating system (for example, Linux or Android) and related micro application software and having built therein a ROM (read only memory) 12 and a RAM (random access memory) 13, a wireless communication module 14 electrically connected to the micro controller unit 11 for establishing a communication protocol interface with a smart phone 90, table computer, notebook computer, or any 3G, 4G, Blue Tooth, or Wi-Fi wireless communication device for reading radio frequency signals, a battery 15 and a power adapter 16 electrically connected in series to the micro controller unit 11 to provide the necessary working voltage.

In actual application, the smart phone 90, table computer, notebook computer, or any 3G, 4G, Blue Tooth, or Wi-Fi wireless communication device can download a control application software, which includes a wireless communication driver and a wireless ID encoder.

Conventional wireless communication devices (smart phones) commonly adopt Wi-Fi technology. The invention supports the network diagnostics framework (NDF) of Wi-Fi system. The aforesaid wireless ID encoder is adapted to encode a NDF identification code. When downloading the aforesaid control application software, the control application software can automatically read in the ID at the first time and then make a cross check prior to starting remote control.

Thus, the invention allows a user to use a smart phone, tablet computer, notebook or any other wireless communication device to control the operation of the central locking system of a car, eliminating the drawback of limited sensing range of conventional infrared type car central locking system remote controllers. Therefore, the invention has significant industrial value.

Although a particular embodiment of the invention has been described in detail for purposes of illustration, various modifications and enhancements may be made without departing from the spirit and scope of the invention. Accordingly, the invention is not to be limited except as by the appended claims.

1. A car central locking system remote control system, comprising:
a wireless communication device;
a central locking system driver installed in a motor vehicle for driving a pull rod to move a mechanical locking mechanism of a central locking system of said motor vehicle to lock or unlock the doors of said motor vehicle; and
a main control box installed in said motor vehicle and electrically connected to said central locking system driver for controlling said central locking system driver to drive said pull rod, said main control box comprising a micro controller unit, a wireless communication module, a read only memory, a random access memory, a battery, and a power adapter, said micro controller unit is adapted for controlling said central locking system driver, said wireless communication module is electrically connected to said micro controller unit and adapted for establishing a communication protocol interface with said wireless communication device for enabling said micro controller unit to be controlled by said wireless communication device to drive said central locking system driver, said battery and said power adapter are electrically connected in series to said micro controller unit.

2. The car central locking system remote control arrangement as claimed in claim 1, further comprising a motor vehicle anti-theft device installed in said motor vehicle and electrically connected to and controllable by said central locking system driver.

3. The car central locking system remote control arrangement as claimed in claim 2, wherein said motor vehicle anti-theft device is selected from a group consisting of an alarm, an automatic fuel shutoff device, a circuit breaker and their combinations.

4. The car central locking system remote control arrangement as claimed in claim 1, wherein said wireless communication device is a smart phone.

5. The car central locking system remote control arrangement as claimed in claim 2, wherein said wireless communication device a smart phone.

6. The car central locking system remote control arrangement as claimed in claim 3, wherein said wireless communication device is a smart phone.

7. The car central locking system remote control arrangement as claimed in claim 1, wherein said wireless communication device is selected from a group consisting of a tablet computer, a notebook computer and a personal computer.

8. The car central locking system remote control arrangement as claimed in claim 2, wherein said wireless communication device is selected from a group consisting of a tablet computer, a notebook computer and a personal computer.

9. The car central locking system remote control arrangement as claimed in claim 3, wherein said wireless communication device is selected from a group consisting of a tablet computer, a notebook computer and a personal computer.

10. The car central locking system remote control arrangement as claimed in claim 1, wherein said wireless communication device has a wireless communication driver and a wireless identification encoder.
